(19) United States
(12) Patent Application Publication
(10) Pub. No.: US 2023/0333987 A1
(43) Pub. Date: Oct. 19, 2023

(54) COMPUTER-READABLE RECORDING MEDIUM, INFORMATION PROCESSING METHOD, AND INFORMATION PROCESSING DEVICE

(71) Applicant: Fujitsu Limited, Kawasaki-shi (JP)

(72) Inventors: Kazuhisa TAKAKURI, Kawasaki (JP); Yukihiro KIMURA, Kawasaki (JP); Masanori YANO, Numazu (JP); Takuya KIRIYAMA, Numazu (JP); Haruhito NAGATA, Numazu (JP); Toshitaka OGATA, Numazu (JP); Terumi KASAI, Mishima (JP); Kenji KAZUMURA, Mishima (JP)

(73) Assignee: Fujitsu Limited, Kawasaki-shi (JP)

(21) Appl. No.: 18/068,217

(22) Filed: Dec. 19, 2022

(30) Foreign Application Priority Data
Apr. 15, 2022 (JP) 2022-067639

(51) Int. Cl. G06F 12/0891; G06F 12/126

(52) U.S. Cl. CPC G06F 12/0891; G06F 12/126

(57) ABSTRACT

A non-transitory computer-readable recording medium stores therein an information processing program causes a computer to execute a process comprising, deleting that, when a cache having codes of a plurality of methods stored therein has insufficient space for storing other codes, includes deleting, from the cache, a first-type code of a first-type method selected from among such other methods which do not include methods listed in a deletion exemption list; and registering the first-type method in the deletion exemption list based on execution duration of the first-type method during period of time that, of a predetermined period of time, is before deletion of the first-type code and during period of time that, of the predetermined period of time, is after deletion of the first-type code, and number of times for which the first-type code is stored in the cache within certain period of time after deletion of the first-type code.

### CROSS-REFERENCE TO RELATED APPLICATION

This application is based upon and claims the benefit of priority of the prior Japanese Patent Application No. 2022-067639, filed on Apr. 15, 2022, the entire contents of which are incorporated herein by reference.

### FIELD

The embodiment discussed herein is related to a computer-readable recording medium, an information processing method, and an information processing device.

### BACKGROUND

A Java program runs when it is executed using JavaVM (VM stands for Virtual Machine) that is software representing an interface between Java programs and the operating system (OS). In the JavaVM, at the time of executing an application in the form of Java programs, there are times when the bytecode is interpreted on a command-by-command basis using an interpreter and then the commands are executed, and there are times when the application is converted into native codes using a dynamic compiler and then the native code are executed.

A native code is generated using a dynamic compiler, and is stored in a memory used in Java processes. The region in the memory in which the native codes are stored and which is used in Java processes is called a “code cache”. Moreover, sometimes the code cache is simply called a “cache”.

On account of being generated in a dynamic manner, a native code gradually goes on increasing in size. In that regard, in order to ensure that the code cache does not use the memory without restriction, an upper limit is set for the size of the memory region that is usable as the code cache. When the upper limit is set for the size of the memory region that is usable as the code cache, it is believed that there occurs a shortage of the code cache in the environment in which a large-scale system is operated for a long period of time. In that situation, the dynamic compiler does not be run, and there is a risk of performance degradation such as a decline in the throughput or a delay in the response time.

As a measure for dealing with that issue, a technology called code cache flushing is available in which, when there occurs a shortage of the code cache, some of the native codes are deleted with the aim of securing a free space in the code cache. As a result of making a free space available by performing code cache flushing, it becomes possible to resume the dynamic compilation. The codes that get deleted due to code cache flushing are then executed in the interpreter until they are again converted into native codes.

As a result of performing code cache flushing, in case a Java method that is important to the performance is temporarily switched to execution in the interpreter, there may be degradation in the performance until that Java method is again converted into a native code by the dynamic compiler.

Moreover, in case there is degradation in the performance of an application, it is difficult to accurately determine whether a shortage in the code cache region has had any impact or whether code cache flushing has had any impact. Conventionally, the data about the size of the code cache is constantly collected, and the timing of performance degradation is figured out and the possibility of an impact of the shortage in the code cache is explored. However, in that method, it is difficult to identify the relationship between the methods that have been switched back to the interpreter for execution and the performance degradation.

As a technology for reducing the futility of recompilation, a technology has been proposed in which, during the operation of erasing functions from the code cache, the importance of each application is defined and control is performed in such a way that the native codes having high importance remain in the code cache for a long period of time.

[Patent Literature] Japanese Laid-open Patent Publication No. 2017-045144

In the conventional code cache flushing, the native codes are sequentially deleted from the code cache in chronological order of dynamic compilation. That is based on the thinking that newly-compiled native codes have a track record of being frequently run in the recent past, and accordingly the older native codes are deleted.

However, depending on the application, there are also times when a method that is important to the performance is compiled at a timing in the past and is used over a long period of time. In such a case, in the conventional code cache flushing, that method might get deleted irrespective of being important to the performance, thereby likely resulting in performance degradation of the JavaVM. In that case, it is possible to think of resolving the performance degradation by means of recompilation. However, in an application in which new methods are compiled one after another, a recompiled method that is important to the performance quickly again becomes an old method. Then, that method which is important to the performance is again treated as the deletion target during code cache flushing, thereby resulting in performance degradation in a repeated manner.

In the case in which the degree of importance and the cache priority of each application is defined in advance in a table and the native codes to be retained are decided according to that definition; since static information is used, deciding on the target native codes for deletion in line with the actual operations becomes a difficult task. For that reason, it is difficult to lessen the degradation in the performance of the computer.

### SUMMARY

According to an aspect of an embodiment, a non-transitory computer-readable recording medium stores therein an information processing program that causes a computer to execute a process includes: deleting that, when a cache having codes of a plurality of methods stored therein has insufficient space for storing other codes, includes referring to a deletion exemption list, and deleting, from the cache, a first-type code of a first-type method selected from among such other methods, from among the plurality of methods, which do not include methods listed in the deletion exemption list; measuring execution duration of the first-type method after every predetermined period of time; and registering the first-type method in the deletion exemption list based on execution duration of the first-type method during period of time that, of the predetermined period of time, is before deletion of the first-type code from the cache and during period of time that, of the predetermined period of time, is after deletion of the first-type code from the cache, and number of times for which the first-type code is stored in the cache within certain period of time after deletion of the first-type code.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a hardware configuration diagram illustrating an example of an information processing device;

FIG. 2 is a system configuration diagram illustrating an example of software used in the information processing device;

FIG. 3 is a block diagram illustrating an example of the information processing device;

FIG. 4 is a diagram illustrating an example of a candidate method list;

FIG. 5 is a diagram illustrating an example of a cumulative performance counter;

FIG. 6 is a diagram illustrating an example of a block performance counter table;

FIG. 7 is a diagram illustrating an example of a X-timing cumulative performance counter and a Y-timing cumulative performance counter;

FIG. 8 is a diagram for explaining an example of generation of the block performance counter table;

FIG. 9 is a diagram for explaining an example of calculation of the block performance counters in response to receiving a code cache flushing notification;

FIG. 10 is a diagram illustrating an example of an increment rate table;

FIG. 11 is a diagram illustrating an example of a recompilation list;

FIG. 12 is a diagram illustrating an example of a flushing method list;

FIG. 13 is a diagram illustrating an example of a deletion exemption list;

FIG. 14 is a flowchart for explaining an example of a compiler thread;

FIG. 15 is a flowchart for explaining an example of a method sampling operation;

FIG. 16 is a flowchart for explaining an example of a sampling data analysis operation; and

FIG. 17 is a flowchart for explaining an example of a code cache flushing operation.

### DESCRIPTION OF EMBODIMENT

Preferred embodiments of the present invention will be explained with reference to accompanying drawings. However, the computer-readable recording medium, the information processing method, and the information processing device according to the application concerned are not limited by the embodiment described below.

### Embodiment

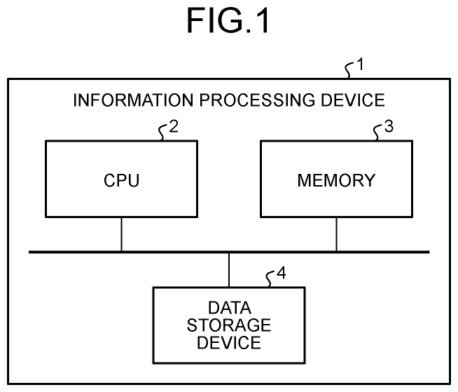

FIG. 1 is a hardware configuration diagram illustrating an example of an information processing device. As illustrated in FIG. 1, an information processing device 1 according to the present embodiment includes a central processing unit (CPU) 2, a memory 3, and a data storage device 4.

The data storage device 4 is an auxiliary storage device. Examples of the data storage device 4 include a hard disk drive (HDD) and a solid state drive (SSD). The data storage device 4 is used to store various computer programs such as the OS, the JavaVM program, and Java programs. Moreover, the data storage device 4 is used to store data such as the results of arithmetic processing.

The memory 3 is a main memory device. Examples of the memory 3 include a dynamic random access memory (DRAM).

The CPU 2 is connected to the memory 3 and the data storage device 4 via a bus. The CPU 2 reads various computer programs from the data storage device 4, loads them in the memory, generates various processes, and executes the processes. For example, the CPU 2 runs the OS and runs the JavaVM in the OS. Then, the CPU 2 executes Java programs using the JavaVM.

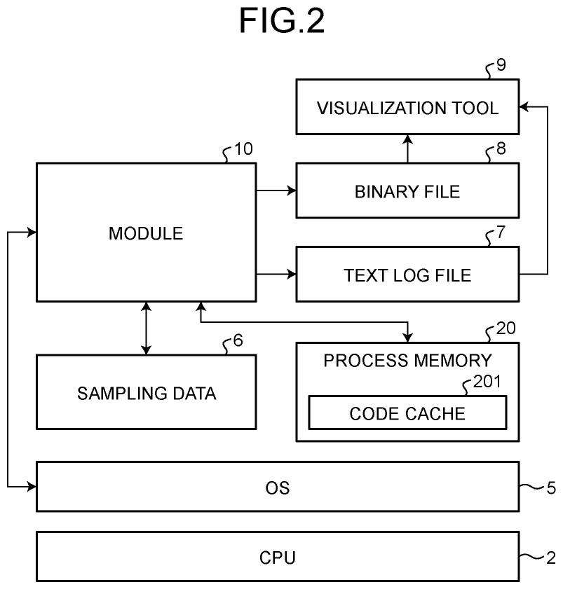

FIG. 2 is a system configuration diagram illustrating an example of software used in the information processing device. The functions of each software component illustrated in FIG. 2 are implemented by the CPU 2.

The CPU 2 runs an OS 5. Moreover, the CPU 2 runs the JavaVM in the OS 5. In the JavaVM, a module 10 is run. The module 10 runs as a result of executing, for example, dynamic link library (dll) files or shared object (so) files. Moreover, the JavaVM is assigned with a process memory 20 that is used by Java processes. The process memory 20 is, for example, a partial region of the memory 3 illustrated in FIG. 1.

The module 10 secures a code cache 201 that is meant for storing the native codes of the Java programs in the process memory 20. Moreover, the module 10 executes Java programs.

For example, the module 10 executes a Java program using an interpreter. Then, regarding each method executed using the interpreter, the module 10 determines whether or not to convert that method into a native code. If it is decided to convert a method into a native code, then the module 10 compiles that method and stores the generated native code in the code cache 201. Subsequently, the module 10 executes that method using the native code stored in the code cache 201.

Moreover, the module 10 receives an instruction from the OS 5 and periodically performs method sampling. As a result of performing method sampling on a periodic basis, the module 10 obtains sampling data 6 that indicates the method-by-method execution counts taken at periodic evaluation blocks during the period of execution of a computer program. Moreover, during code cache flushing, the module 10 discontinues method sampling; and starts method sampling using new evaluation blocks from that point onwards. Then, based on the sampling data 6, from among the native codes stored in the code cache 201 of the process memory 20, the module 10 decides on the native codes to be exempted from deletion. Moreover, the module 10 performs code cache flushing with respect to the other native codes other than the native codes exempted from deletion. Then, the module 10 returns the control to the interpreter for the execution of the methods regarding which the native codes have been deleted.

Furthermore, the module 10 stores, in the data storage device 4 illustrated in FIG. 1, the analysis result of the sampling data 6 and the result of code cache flushing in the form of a binary file 8 or a text log file 7.

A visualization tool 9 is an application running in the OS 5. The visualization tool 9 obtains the binary file 8 and the text log file 7, and generates visualization information meant for visualizing the analysis result of the sampling data 6 and the result of code cache flushing. Then, the visualization tool 9 displays the generated visualization information in a monitor so as to notify the user about the analysis result of the sampling data 6 and the result of code cache flushing.

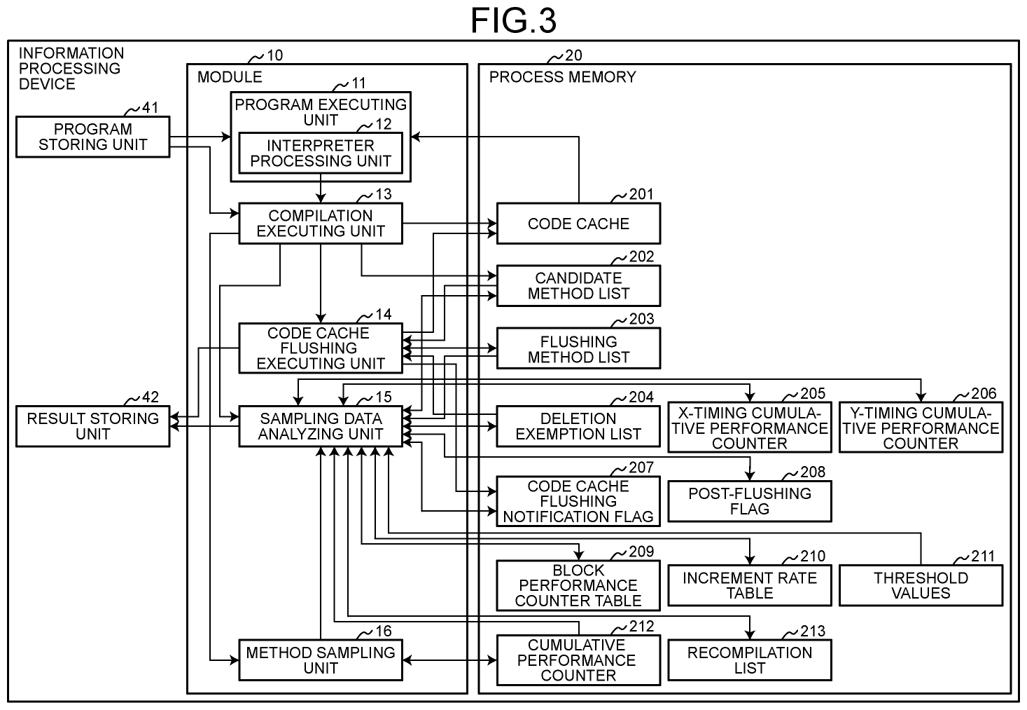

FIG. 3 is a block diagram illustrating an example of the information processing device. The following explanation includes the detailed explanation about the compiler thread used by the module 10, the method sampling result, and the sampling data analysis result. The compiler thread represents a series of operations related to the compilation that includes compilation and code cache flushing.

As illustrated in FIG. 3, the module 10 includes a program executing unit 11, a compilation executing unit 13, a code cache flushing executing unit 14, a sampling data analyzing unit 15, and a method sampling unit 16. The process memory 20 is used to store a candidate method list 202, a flushing method list 203, a deletion exemption list 204, an X-timing cumulative performance counter 205, and a Y-timing cumulative performance counter 206. Moreover, the process memory 20 is used to store a code cache flushing notification flag 207 and a post-flushing flag 208. Furthermore, the process memory 20 is used to store a block performance counter table 209, an increment rate table 210, threshold values 211, a cumulative performance counter 212, and a recompilation list 213.

Meanwhile, the information processing device 1 also includes a program storing unit 41 and a result storing unit 42. The program storing unit 41 and the result storing unit 42 are implemented using, for example, the data storage device 4 illustrated in FIG. 1. The program storing unit 41 is used to store, for example, Java programs. The result storing unit 42 is used to store the result data, including the text log file 7 and the binary file 8 illustrated in FIG. 2, of various operations performed by the module 10.

The program executing unit 11 reads computer programs from the program storing unit 41. Then, either according to the interpreter-based execution or according to the execution using the native codes, the program executing unit 11 executes the methods included in the computer programs.

The program executing unit 11 includes an interpreter processing unit 12. In the case of interpreter-based execution of a method, the interpreter processing unit 12 interprets the bytecodes of the target method one by one, and executes the method.

The interpreter processing unit 12 selects a method that satisfies a predetermined condition such as the execution frequency. Then, the interpreter processing unit 12 outputs a translation request regarding the selected method to the compilation executing unit 13.

In the case of executing a method using the native code, the program executing unit 11 obtains the native code of the target method from the code cache 201 and executes that method.

The compilation executing unit 13 performs dynamic compilation. The compilation executing unit 13 receives a translation request regarding a method from the interpreter processing unit 12. Then, from the Java programs stored in the program storing unit 41, the compilation executing unit 13 obtains the information about the method about which the translation request is received.

Then, the compilation executing unit 13 determines whether or not there is sufficient free space in the code cache 201 for storing the native code of the target method. If there is sufficient space in the code cache 201, then the compilation executing unit 13 determines whether or not a code cache flushing condition, which is decided in advance based on the read count of each native code, is satisfied. If the code cache flushing condition is not satisfied, then the compilation executing unit 13 performs compilation, translates the obtained method, and generates a native code. Subsequently, the compilation executing unit 13 stores the generated native code in the code cache 201.

On the other hand, if there is no sufficient space in the code cache 201 or if the code cache flushing condition is satisfied, then the compilation executing unit 13 requests the code cache flushing executing unit 14 to perform code cache flushing.

At that time, the compilation executing unit 13 selects the candidate methods for code cache flushing. For example, in order to secure free space in the code cache 201, the compilation executing unit 13 selects a sufficient number of candidate methods in chronological order of dynamic compilation of the native codes, and generates the candidate method list 202 in which the selected candidate methods are listed.

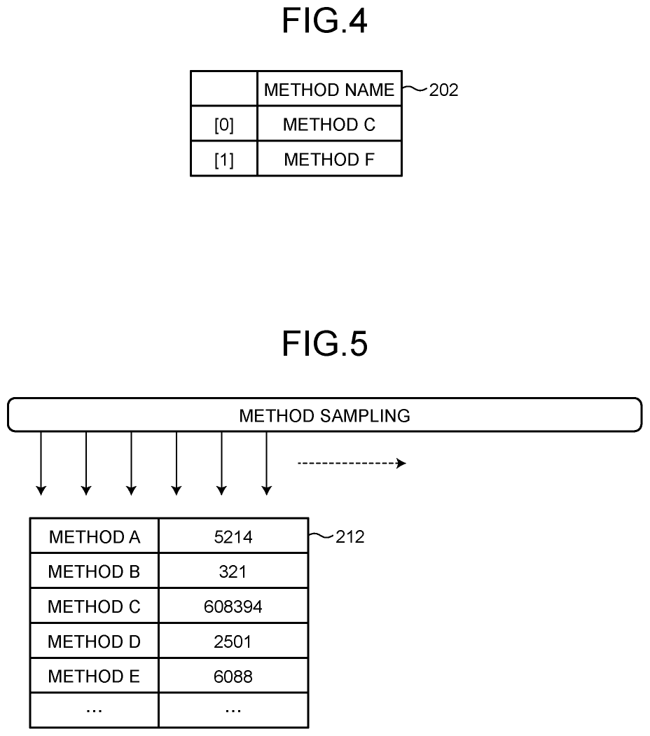

FIG. 4 is a diagram illustrating an example of the candidate method list. For example, the compilation executing unit 13 registers, in the candidate method list 202 as illustrated in FIG. 4, the names of the candidate methods as the method identifiers of the candidate methods. With reference to FIG. 4, the numbers written on the left side represent serial numbers assigned to the methods listed in the candidate method list 202. The compilation executing unit 13 stores the candidate method list 202 in the process memory 20.

Returning to the explanation with reference to FIG. 1, the method sampling unit 16 performs, at periodic specific intervals, method sampling with respect to the methods executed by the program executing unit 11. The method sampling unit 16 performs method sampling by extracting the methods that are being executed by the program executing unit 11 at that point of time. The extraction count of each method during method sampling is expressed as a performance counter. A method extracted during method sampling, which is performed at specific intervals, represents a method being executed at that point of time. That is, the extraction count can be said to represent the execution duration of the concerned method.

The method sampling unit 16 performs method sampling on an ongoing basis at short intervals, such as after every few hundred milliseconds, that do not affect the performance. As a result, the method sampling unit 16 obtains the sampling data 6 indicating the extraction count of each method at specific intervals during the execution of the concerned computer program. Then, the method sampling unit 16 adds the method-by-method sampling data 6 to the cumulative performance counter 212.

FIG. 5 is a diagram illustrating an example of the cumulative performance counter. The cumulative performance counter 212 includes counters associated to the names of the methods. In the cumulative performance counter 212, the value of each count indicates the cumulative number of times for which the corresponding method has been extracted.

The method sampling unit 16 performs method sampling on an ongoing basis as illustrated in FIG. 5, and periodically updates the values in the cumulative performance counter 212. With reference to FIG. 5, the arrows extending from the method sampling portion indicate the updating of the cumulative performance counter 212 performed by the method sampling unit 16 at the specific intervals. The method sampling unit 16 repeatedly performs periodic method sampling until the processes of the Java program end or until an instruction to stop the sampling is received.

Returning to the explanation with reference to FIG. 3, the sampling data analyzing unit 15 refers to the sampling data 6 and monitors the changes in the value of the performance counter regarding each method within a predetermined evaluation block of, for example, 10 seconds. Herein, the duration of the evaluation block is equivalent to an example of a “predetermined period”. Then, the sampling data analyzing unit 15 evaluates the changes in the execution duration of each method according to the changes occurring in the performance counter within 10 seconds immediately before the execution of code cache flushing and within 10 seconds immediately after the execution of code cache flushing. That is, in order to evaluate the execution duration of each method, the sampling data analyzing unit 15 uses the corresponding value in the performance counter obtained as a result of method sampling, instead of using the CPU time consumed for method execution. Herein, the values in the performance counter obtained as a result of performing method sampling at predetermined intervals can be evaluated at an equivalent level to the CPU time consumed by the methods during the concerned period of time; and method sampling can be performed with less load as compared to the measurement of the consumed CPU time. However, if an increase in the load is acceptable, then the sampling data analyzing unit 15 can evaluate the execution duration of the methods using the consumed CPU time. With that, it is possible to evaluate the execution duration in a more accurate manner.

Regarding a method that gets deleted during code cache flushing, if there is a significant increase in the value of the performance counter in the period of time before the execution of code cache flushing and in the period of time after the execution of code cache flushing, then the sampling data analyzing unit 15 determines that the execution duration got extended. Then, regarding the method for which the execution duration got extended, the sampling data analyzing unit 15 determines that changing the execution of the method from the execution according to the native code to the execution using the interpreter has a significant impact on performance degradation of the CPU 2. That is, the sampling data analyzing unit 15 treats the change in the values in the performance counter before and after the execution of code cache flushing as the degree of impact of the methods on the performance of the CPU 2. Moreover, the sampling data analyzing unit 15 calculates, for each method, the recompilation count and the execution period and determines that a method having a high recompilation count and a long execution period is an important method. That is, the sampling data analyzing unit 15 determines the degree of importance of each method according to the recompilation count and the execution period. Subsequently, the sampling data analyzing unit 15 exempts, from the target methods for deletion during code cache flushing, such methods which have the degree of impact and the degree of importance satisfying predetermined conditions. Given below is the detailed explanation of the operations performed by the sampling data analyzing unit 15. Herein, the evaluation block is assumed to be of 10 seconds.

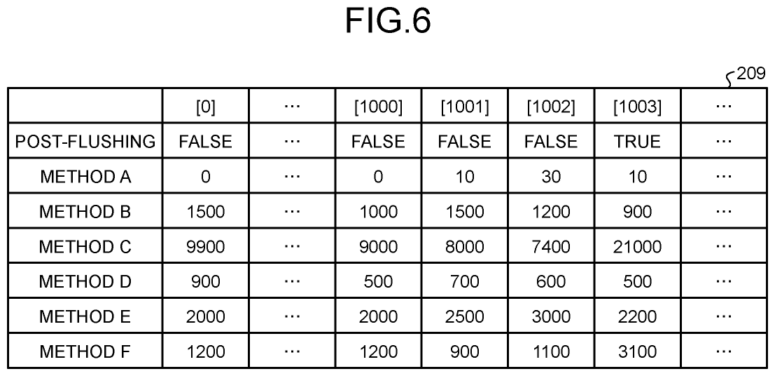

The sampling data analyzing unit 15 repeatedly performs the following operations at the intervals of 10 seconds. The sampling data analyzing unit 15 adds a new column corresponding to the current evaluation block at the end of the block performance counter table 209 illustrated in FIG. 6. FIG. 6 is a diagram illustrating an example of the block performance counter table.

In the block performance counter table 209 illustrated in FIG. 6, the uppermost row includes numbers assigned as serial numbers to the evaluation blocks in the block performance counter table 209. As illustrated in FIG. 6, in the block performance counter table 209, the method-by-method counter values are registered for each evaluation block. In each evaluation block, the counter values represent the amount of increase in the counters during the corresponding evaluation period. Moreover, in the block performance counter table 209, a post-flushing flag is set for each evaluation block. In the block performance counter table 209, each post-flushing flag is set to true or false. When set to true, the post-flushing flag indicates that code cache flushing was performed immediately before the concerned evaluation block. On the other hand, when set to false, the post-flushing flag indicates that code cache flushing was not performed immediately before the concerned evaluation block.

Returning to the explanation with reference to FIG. 3, the sampling data analyzing unit 15 performs initialization by which, in the newly-added column, the post-flushing flag is set to false and the counter value corresponding to each method identifier I set to “0”.

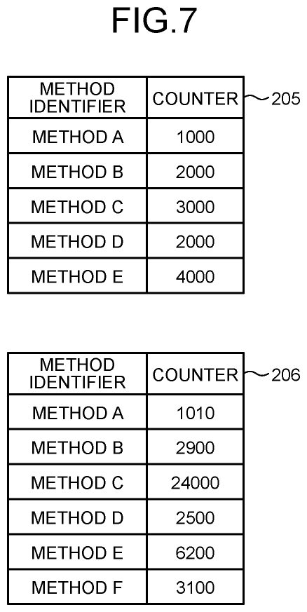

Then, the sampling data analyzing unit 15 deletes all method identifiers and all counter values registered in the X-timing cumulative performance counter 205. The X-timing cumulative performance counter 205 holds the counter values of the cumulative performance counter 212 in an evaluation block. FIG. 7 is a diagram illustrating an example of the X-timing cumulative performance counter and the Y-timing cumulative performance counter. In the X-timing cumulative performance counter 205, the method identifiers and the counter values are registered in a corresponding manner.

Subsequently, the sampling data analyzing unit 15 obtains the method identifier and the counter value of each method, which is registered in the cumulative performance counter 212, at that point of time. Then, the sampling data analyzing unit 15 registers the obtained method identifier and the obtained counter value in the X-timing cumulative performance counter 205.

After performing new registration in the X-timing cumulative performance counter 205, the sampling data analyzing unit 15 waits for 10 seconds that represent the evaluation block. During the 10 seconds of waiting, the sampling data analyzing unit 15 monitors the code cache flushing notification flag 207 and determines whether or not a notification of execution of code cache flushing is received from the code cache flushing executing unit 14.

The code cache flushing notification flag 207 is set to true or false. When set to true, the code cache flushing notification flag 207 indicates that code cache flushing has been performed. On the other hand, when set to false, the code cache flushing notification flag 207 indicates that code cache flushing has not been performed. Thus, the code cache flushing notification flag 207 is set to true during code cache flushing performed by the code cache flushing executing unit 14 as explained later, and is reset to false by the sampling data analyzing unit 15 after receiving the notification.

If a notification about the execution of code cache flushing is not received during the 10 seconds of waiting, the sampling data analyzing unit 15 deletes all method identifiers and all counter values registered in the Y-timing cumulative performance counter 206. The Y-timing cumulative performance counter 206 holds the counter values of the last cumulative performance counter 212 in an evaluation block. As illustrated in FIG. 7, in the Y-timing cumulative performance counter 206 too, the method identifiers and the counter values are registered in a corresponding manner.

Subsequently, the sampling data analyzing unit 15 obtains the method identifier and the counter value of each method, which is registered in the cumulative performance counter 212, at that point of time. Then, the sampling data analyzing unit 15 registers the obtained method identifier and the obtained counter value in the Y-timing cumulative performance counter 206.

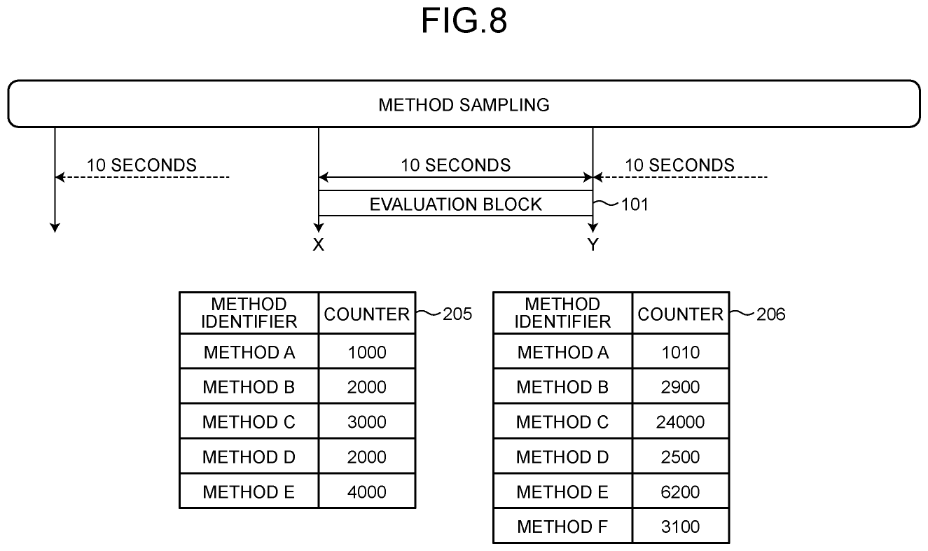

For each evaluation block, using the X-timing cumulative performance counter 205 and the Y-timing cumulative performance counter 206, the sampling data analyzing unit 15 registers, in the block performance counter table 209, the counter value of each method in that evaluation block. FIG. 8 is a diagram for explaining an example of generation of the block performance counter table. Thus, given below is the detailed explanation about generating the block performance counter table 209.

The sampling data analyzing unit 15 generates the X-timing cumulative performance counter 205 at a timing X illustrated in FIG. 8, and generates the Y-timing cumulative performance counter 206 at a timing Y arriving after 10 seconds. Then, the sampling data analyzing unit 15 subtracts the counter values of all method identifiers registered in the X-timing cumulative performance counter 205 from the counter values of the corresponding method identifiers registered in the Y-timing cumulative performance counter 206. As a result, the sampling data analyzing unit 15 calculates the block performance counter value of each method in an evaluation block 101. Then, the sampling data analyzing unit 15 collectively sets, in the last column of the block performance counter table 209, the block performance counter values that correspond to the method identifiers and that are obtained from the subtraction result. Moreover, the sampling data analyzing unit 15 retains the post-flushing flag to false.

Meanwhile, at the time of subtraction, if no method identifier is specified in the X-timing cumulative performance counter 205, then the sampling data analyzing unit 15 subtracts “0”. Moreover, regarding a method whose method identifier is not registered in the Y-timing cumulative performance counter 206; the sampling data analyzing unit 15 registers, in the block performance counter table 209, information indicating that the block performance counter value is indeterminate. Furthermore, regarding a method identifier not registered in the block performance counter table 209, the sampling data analyzing unit 15 adds a new row corresponding to the method identifier at the end of the block performance counter table 209, and registers a block performance counter value.

Subsequently, the sampling data analyzing unit 15 outputs the information, which is recorded in the block performance counter table 209, as the text log file 7 or the binary file 8 and stores it in the result storing unit 42.

Meanwhile, if a notification about the execution of code cache flushing is received during the 10 seconds of waiting, then the sampling data analyzing unit 15 sets the code cache flushing notification flag 207 to false. Moreover, the sampling data analyzing unit 15 sets the post-flushing flag to true for the newly-added column in the block performance counter table 209. Then, the sampling data analyzing unit 15 calculates the block performance counter values for the new evaluation block starting from that point of time.

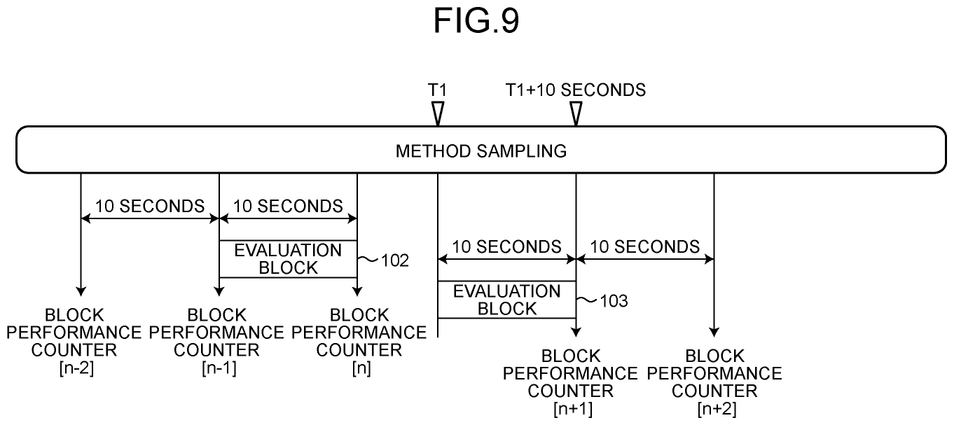

FIG. 9 is a diagram for explaining an example of calculation of the block performance counters in response to receiving a code cache flushing notification. In FIG. 9, each arrow extending from the method sampling portion points to the number assigned to the block performance counter calculated at that point of time. Herein, the numbers assigned to the block performance counters represent the serial numbers of the block performance counters registered in the block performance counter table 209. The sampling data analyzing unit 15 calculates the block performance counter values in the range from n−2 to n+2. In FIG. 9 is illustrated the case in which the sampling data analyzing unit 15 receives a code cache flushing notification at a timing T1.

The sampling data analyzing unit 15 sequentially calculates the block performance counters in the sequence of the n−2-th block performance counter, the n−1-th block performance counter, and the n-th block performance counter; and registers them in the block performance counter table 209. The counter value of the n-th block performance counter is in an evaluation block 102. When the code cache flushing notification is received at the timing T1, the sampling data analyzing unit 15 stops the calculation of the counter block performance counter values that was started immediately after the evaluation block 102; and starts a new evaluation block 103 from the timing T1. Then, the sampling data analyzing unit 15 calculates the value of the n+1-th block performance counter after the elapse of 10 seconds from the timing T1. In the same manner, after every 10 seconds, the sampling data analyzing unit 15 repeatedly calculates a counter block performance counter value from the n+2-th block performance counter onward.

In the present embodiment, if the information about the evaluation blocks in the block performance counter table 209 indicates less than four columns, then the sampling data analyzing unit 15 keeps adding the counter values corresponding to each method identifier until four or more columns are present. When the information about the evaluation block indicates four or more columns, the sampling data analyzing unit 15 calculates, in the manner explained below, the increment rate of the block performance counter of each method registered in the block performance counter table 209.

More specifically, the sampling data analyzing unit 15 obtains, as the current block performance counter values, the block performance counter values of the last column in the block performance counter table 209. Moreover, the sampling data analyzing unit 15 calculates the average value of the block performance counter values of the methods from the fourth-last column to the second-last column in the block performance counter table 209, and treats the average value as the past block performance counter value. Then, the sampling data analyzing unit 15 divides the current block performance counter values by the past block performance counter value, and calculates the increment rate of the block performance counters. If the block performance counter values in the past three instances have the average value equal to “0”, then the sampling data analyzing unit 15 sets the increment rate of the performance counter of that method to “1”.

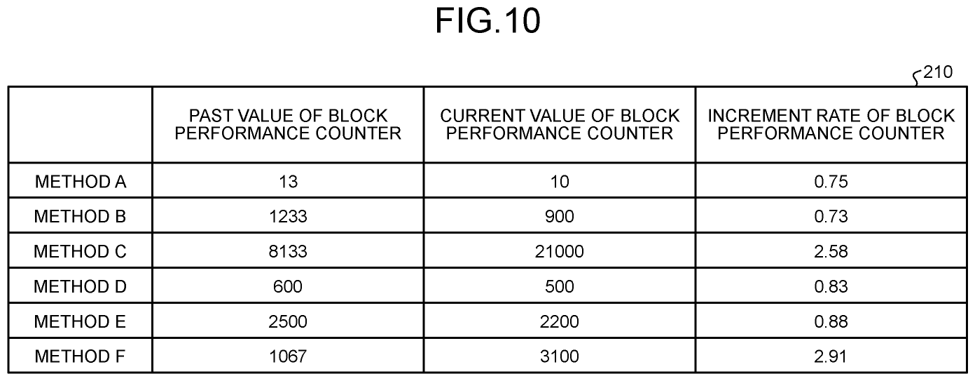

FIG. 10 is a diagram illustrating an example of the increment rate table. The sampling data analyzing unit 15 generates the increment rate table 210 in which the past block performance counter value, the current block performance counter value, and the increment rate of the block performance counter are registered for each method. In the present embodiment, the average value of the past three block performance counters is treated as the past block performance counter value. Alternatively, as long as the past block performance counter value expresses the trend of the block performance counter value till that point of time, it is also possible to use some other value. For example, as the past block performance counter value, the sampling data analyzing unit 15 can use the average value of three or more of the past block performance counters or can use the counter value of the previous block performance counter.

Subsequently, the sampling data analyzing unit 15 outputs the increment rate of the block performance counter of each method in the form of the text log file 7 or the binary file 8, and stores it in the result storing unit 42. Alternatively, the sampling data analyzing unit 15 can output the increment rate table 210 in the form of the text log file 7 or the binary file 8, and store it in the result storing unit 42.

Returning to the explanation with reference to FIG. 3, subsequently, the sampling data analyzing unit 15 determines whether or not the post-flushing flag 208 is set to true for the last column in the block performance counter table 209. If the post-flushing flag 208 is set to false, then the sampling data analyzing unit 15 determines that the code cache flushing is not performed, and ends the analysis of the sampling data 6 in the current evaluation block.

On the other hand, if the post-flushing flag 208 is set to true, then the sampling data analyzing unit 15 determines that code cache flushing has been performed. Then, the sampling data analyzing unit 15 obtains, from the compilation executing unit 13, the information of all methods that were compiled within 10 seconds after the execution of code cache flushing. Moreover, the sampling data analyzing unit 15 obtains, from the flushing method list 203, the methods that were deleted during the previous execution of code cache flushing. Then, the sampling data analyzing unit 15 confirms whether or not the deleted methods were recompiled within 10 seconds after the execution of code cache flushing.

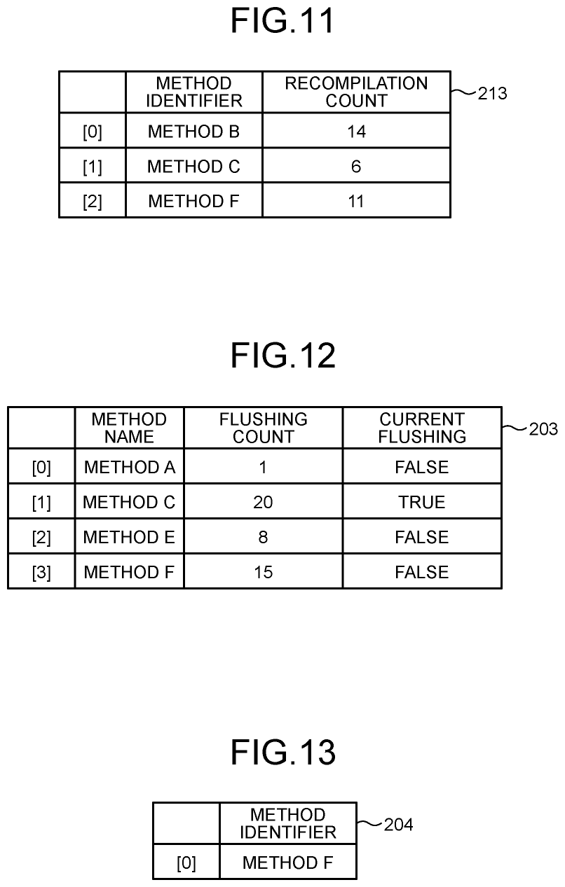

Then, the sampling data analyzing unit 15 identifies, from among the deleted methods, the methods that were recompiled within 10 seconds after the execution of code cache flushing, and updates the recompilation list 213 stored in the process memory 20. FIG. 11 is a diagram illustrating an example of the recompilation list. In the recompilation list 213, regarding each method, a recompilation count is specified that indicates the number of times for which that method was recompiled within 10 seconds after being deleted during code cache flushing. In the recompilation list 213, with reference to FIG. 11, the numbers written on the left side represent the serial numbers assigned to the methods in the recompilation list 213. Thus, the recompilation count represents the number of times of occurrence of an event in which a first-type code that, after being deleted, is stored in the code cache 201 within a certain period of time. In the present embodiment, the condition regarding the recompilation count is that the recompilation is performed within the same 10 seconds as the duration of the evaluation block present after the execution of code cache flushing. However, the certain period of time can alternatively be different than the duration of the evaluation block. For example, the sampling data analyzing unit 15 can calculate the recompilation count under the condition that the recompilation is performed within a shorter period of time than the duration of the evaluation block.

More specifically, the sampling data analyzing unit 15 increments, in the recompilation list 213, the recompilation count of each such method which is identified to have been recompiled within 10 seconds after being deleted during code cache flushing. If the method identifier of such an identified method is not registered in the recompilation list 213, then the sampling data analyzing unit 15 adds a new row in the recompilation list 213. Subsequently, the sampling data analyzing unit 15 registers the method identifier of the identified method in the added row, and sets the recompilation count to “1”.

Then, the sampling data analyzing unit 15 outputs the recompilation counts of the methods, which are registered in the recompilation list 213, in the form of the text log file 7 or the binary file 8; and stores it in the result storing unit 42.

Returning to the explanation with reference to FIG. 3, the sampling data analyzing unit 15 selects one method at a time from the increment rate table 210 and repeatedly performs a deletion-exemption-method determination operation. Given below is the detailed explanation of the deletion-exemption-method determination operation.

The sampling data analyzing unit 15 obtains an impact degree threshold value, a constant execution threshold value, and a nonefficiency threshold value included as the threshold values 211 stored in advance in the process memory 20.

The impact degree threshold value is meant for determining about the possibility of an extension in the execution duration of the interpreter-based execution of the concerned method after the execution of code cache flushing. The impact degree threshold value is used in determining the degree of impact of code cache flushing regarding each method on the performance degradation of the information processing device 1. The impact degree threshold value is a corresponding value to the increment rate. For example, when the result of the operations represents the increment rate table 210 illustrated in FIG. 10, the impact degree threshold value can be set to “2”. The impact degree threshold value represents an example of a “first threshold value”.

The constant execution threshold value is meant for determining whether or not, in the computer program being executed, the concerned method is repeatedly executed over a period of time that is long enough to be considered important. The nonefficiency threshold value is meant for determining if the concerned method has a large recompilation count due to code cache flushing, thereby making the method nonefficient. The constant execution threshold value and the nonefficiency threshold value are used in determining the degree of importance of each method during the execution of a Java program. The constant execution threshold value is a corresponding value to the block performance counter. For example, if the result of the operations is the increment rate table 210 illustrated in FIG. 10, then the constant execution threshold value can be set to “1000”. The nonefficiency threshold value is a corresponding value to the recompilation count. For example, if the result of the operations is the recompilation list 213 illustrated in FIG. 11, then the nonefficiency threshold value can be set to “10”. The constant execution threshold value represents an example of a “second threshold value”, and the nonefficiency threshold value represents an example of a “third threshold value”.

The sampling data analyzing unit 15 obtains, from the increment rate table 210, the past block performance counter value of the selected method and the increment rate of the block performance counter of the selected method. Moreover, the sampling data analyzing unit 15 obtains the recompilation count of the selected method from the recompilation list 213.

Furthermore, the sampling data analyzing unit 15 obtains, from the flushing method list 203, the information about a current-flushing flag of the selected method. FIG. 12 is a diagram illustrating an example of the flushing method list. The flushing method list 203 indicates whether or not a method was deleted during the previous execution of code cache flushing. In the flushing method list 203, as illustrated in FIG. 12, the flushing count and the current-flushing flag are registered for each method. If the current-flushing flag is set to false, it indicates that the concerned method was not deleted during the previous execution of code cache flushing. If the current-flushing flag is set to true, it indicates that the concerned method was deleted during the previous execution of code cache flushing. With reference to the flushing method list 203 illustrated in FIG. 12, the numbers written on the left side represent serial numbers assigned to the methods listed in the flushing method list 203. As explained later, the flushing method list 203 is generated by the code cache flushing executing unit 14.

If the current-flushing flag is set to true for the selected method, then the sampling data analyzing unit 15 performs determination in the following manner. The sampling data analyzing unit 15 determines whether or not the increment rate of the block performance count is equal to or greater than the impact degree threshold value. Then, the sampling data analyzing unit 15 determines whether or not the past block performance counter value is equal to or greater than the constant execution threshold value. Moreover, the sampling data analyzing unit 15 determines whether or not the recompilation count is equal to or greater than the nonefficiency threshold value. If the impact degree threshold value, the constant execution threshold value, and the nonefficiency threshold value are equaled or exceeded, then the sampling data analyzing unit 15 determines that the selected method satisfies a flushing exemption condition. Then, the sampling data analyzing unit 15 registers, in the deletion exemption list 204 regarding code cache flushing, the method satisfying the flushing exemption condition.

FIG. 13 is a diagram illustrating an example of the deletion exemption list. As illustrated in FIG. 13, the sampling data analyzing unit 15 registers, in the deletion exemption list 204, the method identifier of each method that is exempted from deletion during code cache flushing.

That is, the sampling data analyzing unit 15 registers, in the deletion exemption list 204, the methods that satisfy the following flushing exemption conditions. The first deletion exemption condition is that the increment rate of the execution duration of a first-type method in the latter period of time with respect to the execution duration of the first-type method in the earlier period of time is equal to or greater than a first threshold value. The second deletion exemption condition is that the execution duration in the earlier period of time is equal to or greater than a second threshold value. The third deletion exemption condition is that the event in which a first-type code is stored in the code cache 201 within a certain period of time after being deleted occurs for a number of times equal to or greater than a third threshold value.

Returning to the explanation with reference to FIG. 3, the sampling data analyzing unit 15 repeatedly performs the deletion-exemption-method determination operation regarding all methods registered in the increment rate table 210. Then, the sampling data analyzing unit 15 outputs the information about the methods, which are registered in the deletion exemption list 204, in the form of the text log file 7 and the binary file 8; and stores it in the result storing unit 42. Moreover, the sampling data analyzing unit 15 sets the post-flushing flag to true for the current evaluation block in the block performance counter table 209.

The sampling data analyzing unit 15 represents an example of an “analyzing unit”. That is, the sampling data analyzing unit 15 registers the first-type method in the deletion exemption list 204 based on: the execution duration of the first-type method as measured after every predetermined period of time; the execution duration of the first-type method in the period of time, from among a predetermined period of time, before as well as after deletion of the first-type code from the code cache 201; and the number of times for which the first-type code is stored in the cache within a certain period of time after being deleted.

The code cache flushing executing unit 14 receives a request for code cache flushing from the compilation executing unit 13. Then, the code cache flushing executing unit 14 sets all information about the current flushing to false in the flushing method list 203. Subsequently, the code cache flushing executing unit 14 obtains the candidate method list 202 from the process memory 20. Moreover, the code cache flushing executing unit 14 obtains the deletion exemption list 204 from the process memory 20.

Then, the code cache flushing executing unit 14 determines whether each candidate method registered in the candidate method list 202 is also registered in the deletion exemption list 204. Subsequently, the code cache flushing executing unit 14 deletes, from the code cache 201, such candidate methods which are registered in the candidate method list 202 but are not registered in the deletion exemption list 204.

Then, the code cache flushing executing unit 14 updates the flushing method list 203, which is stored in the process memory 20 and illustrated in FIG. 12. More particularly, if any of the deleted methods is still not registered in the flushing method list 203, then the code cache flushing executing unit 14 adds the method identifier of that method in the flushing method list 203. Subsequently, the code cache flushing executing unit 14 sets the flushing count corresponding to the added method identifier to “1”, and sets the current-flushing flag to true. Moreover, regarding the deleted methods that are already registered in the flushing method list 203, the code cache flushing executing unit 14 increments, by one, the flushing count corresponding to the method identifiers of those methods. Furthermore, the code cache flushing executing unit 14 sets the current-flushing flag to true.

Then, the code cache flushing executing unit 14 sets the code cache flushing notification flag 207 to true. With that, the code cache flushing executing unit 14 notifies the sampling data analyzing unit 15 about the execution of code cache flushing. Moreover, the code cache flushing executing unit 14 outputs the flushing method list 203 in the form of the text log file 7 or the binary file 8; and stores it in the result storing unit 42.

Furthermore, the code cache flushing executing unit 14 performs fragment state analysis of the code cache 201 after the execution of code cache flushing, and confirms the state of the fragments. Then, the code cache flushing executing unit 14 outputs the information about the fragment state of the code cache 201 in the form of the text log file 7 or the binary file 8, and stores it in the result storing unit 42.

The code cache flushing executing unit 14 represents an example of a “deleting unit”. That is, if the cache in which the codes of a plurality of methods are stored has insufficient space for storing other codes, then the code cache flushing executing unit 14 refers to the deletion exemption list 204 and deletes, from the code cache 201, the first-type codes of the first-type methods selected from among a plurality of methods excluding the methods specified in the deletion exemption list 204.

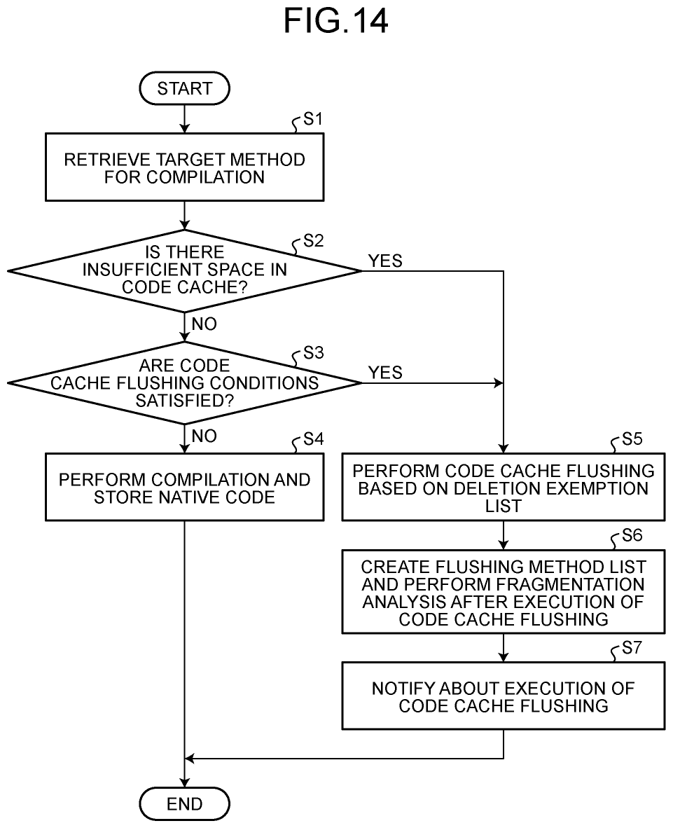

FIG. 14 is a flowchart for explaining an example of the compiler thread. Thus, explained below with reference to FIG. 14 is the flow of operations performed in the compiler thread by the information processing device 1.

The interpreter processing unit 12 selects a method that satisfies a predetermined condition. Then, the interpreter processing unit 12 issues a translation request regarding the selected method to the compilation executing unit 13. Thus, the compilation executing unit 13 receives the translation request regarding the method from the interpreter processing unit 12. Then, the compilation executing unit 13 retrieves the method, for which the translation request is received, from a Java program stored in the program storing unit 41 (Step S1).

Subsequently, the compilation executing unit 13 determines whether or not there is insufficient space in the code cache 201 for the obtained method (Step S2).

If there is no shortage of space in the code cache 201 (No at Step S2), then the compilation executing unit 13 determines whether or not a predetermined condition for code cache flushing is satisfied (Step S3).

If the condition for code cache flushing is not satisfied (No at Step S3), then the compilation executing unit 13 compiles and translates the obtained method, and generates a native code. Subsequently, the compilation executing unit 13 stores the generated native code in the code cache 201 (Step S4).

On the other hand, if there is insufficient space in the code cache 201 (Yes at Step S2) or if the condition for code cache flushing is satisfied (Yes at Step S3), then the compilation executing unit 13 performs the following operations. Firstly, the compilation executing unit 13 requests the code cache flushing executing unit 14 to perform code cache flushing. Moreover, the compilation executing unit 13 selects the candidate methods for code cache flushing. Then, the compilation executing unit 13 generates the candidate method list 202 in which the selected candidate methods are listed. The code cache flushing executing unit 14 receives the request for performing code cache flushing, and performs code cache flushing based on the deletion exemption list 204 (Step S5).

After performing code cache flushing, the code cache flushing executing unit 14 creates the flushing method list 203. Moreover, the code cache flushing executing unit 14 performs fragment state analysis of the code cache 201 after the execution of code cache flushing (Step S6).

Subsequently, the code cache flushing executing unit 14 uses the code cache flushing notification flag 207 and notifies the sampling data analyzing unit 15 about the execution of code cache flushing (Step S7).

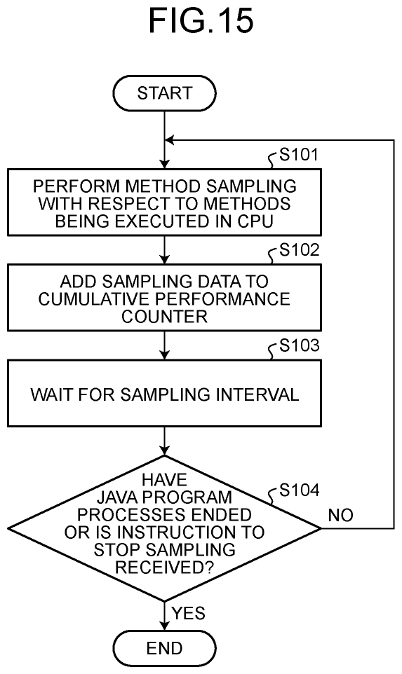

FIG. 15 is a flowchart for explaining an example of a method sampling operation. Thus, explained below with reference to FIG. 15 is the flow of the method sampling operation performed by the method sampling unit 16.

The method sampling unit 16 performs method sampling with respect to the methods being executed by the CPU 2 (Step S101).

Then, the method sampling unit 16 adds the method-by-method sampling data 6 in the cumulative performance counter 212 (Step S102).

Subsequently, the method sampling unit 16 waits for a sampling interval that is a specific time interval (Step S103).

Then, the method sampling unit 16 determines whether or not the processes of the Java program have ended or an instruction to stop the sampling is received (Step S104). If the processes of the Java program have not ended and if an instruction to stop the sampling is not received (No at Step S104), then the system control returns to Step S101.

On the other hand, if the processes of the Java program have ended or if an instruction to stop the sampling is received (Yes at Step S104), then the method sampling unit 16 ends the method sampling operation.

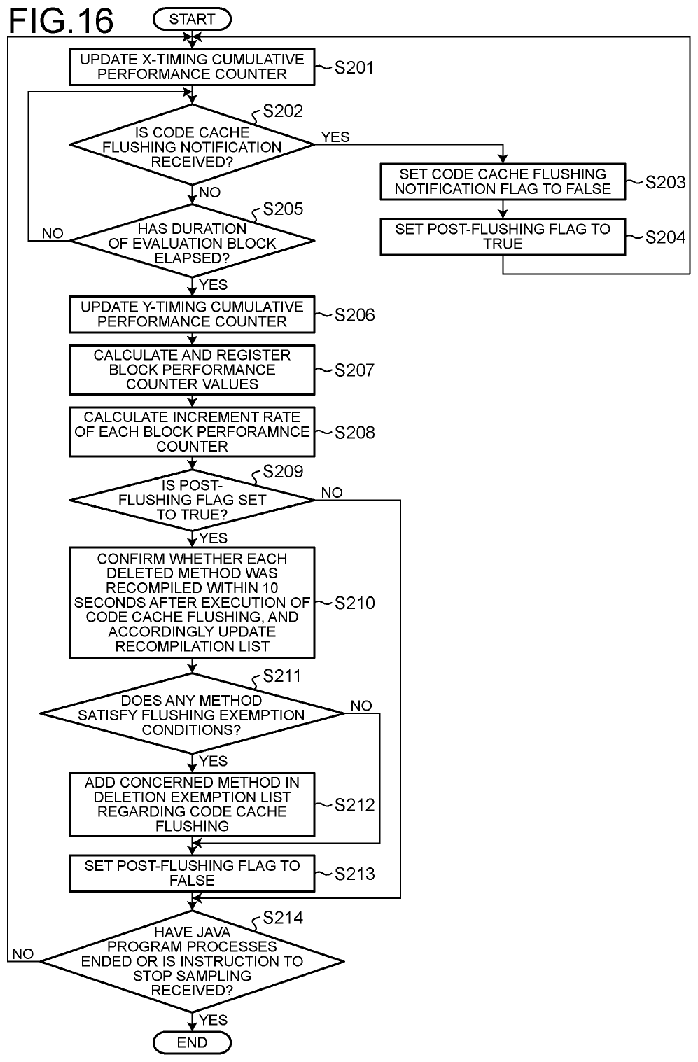

FIG. 16 is a flowchart for explaining an example of a sampling data analysis operation. Thus, explained below with reference to FIG. 16 is the flow of the sampling data analysis operation performed by the sampling data analyzing unit 15. Herein, the explanation is given for the case in which the calculation interval of the block performance counter is set to 10 seconds.

The sampling data analyzing unit 15 adds, at the end of the block performance counter table 209, a new column corresponding to the current evaluation block. The sampling data analyzing unit 15 sets the post-flushing flag of the newly-added column to false, and initializes the counter value corresponding to each method identifier to “0”. Then, the sampling data analyzing unit 15 deletes all method identifiers and all counter values registered in the X-timing cumulative performance counter 205. Moreover, the sampling data analyzing unit 15 obtains the method identifiers and the counter values of the methods registered in the cumulative performance counter 212 at that point of time. Then, the sampling data analyzing unit 15 registers the obtained method identifiers and the obtained counter values in the X-timing cumulative performance counter 205, and updates the X-timing cumulative performance counter 205 (Step S201).

Subsequently, the sampling data analyzing unit 15 waits for 10 seconds, which represent the duration of the evaluation block, after the updating of the X-timing cumulative performance counter 205. During that time, the sampling data analyzing unit 15 monitors the code cache flushing notification flag 207, and determines whether or not a code cache flushing notification is received from the code cache flushing executing unit 14 during those 10 seconds of waiting (Step S202).

If a code cache flushing notification is received during the wait (Yes at Step S202), then the sampling data analyzing unit 15 sets the code cache flushing notification flag 207 to false (Step S203).

Moreover, the sampling data analyzing unit 15 sets the post-flushing flag of the newly-added column in the block performance counter table 209 to true (Step S204). Then, the system control returns to Step S201.

On the other hand, if a code cache flushing notification is not received (No at Step S202), then the sampling data analyzing unit 15 determines whether or not 10 seconds representing the duration of the evaluation block have elapsed (Step S205). If the duration of the evaluation block has not elapsed (No at Step S205), then the system control returns to Step S202.

On the other hand, if the duration of the evaluation block has elapsed without receiving a code cache flushing notification (Yes at Step S205), then the sampling data analyzing unit 15 deletes all method identifiers and all counter values registered in the Y-timing cumulative performance counter 206. Then, the sampling data analyzing unit 15 obtains the method identifier and the counter value of each method registered in the cumulative performance counter 212 at that point of time. Then, the sampling data analyzing unit 15 registers the obtained method identifiers and the obtained counter values in the Y-timing cumulative performance counter 206, and updates the Y-timing cumulative performance counter 206 (Step S206).

Subsequently, the sampling data analyzing unit 15 subtracts, from the counter values of all method identifiers registered in the Y-timing cumulative performance counter 206, the counter values of the same method identifiers registered in the X-timing cumulative performance counter 205. As a result, the sampling data analyzing unit 15 calculates the block performance counter value in the evaluation block 101. Subsequently, the sampling data analyzing unit 15 collectively registers, in the last column in the block performance counter table 209, the block performance counter values corresponding to all method identifiers as obtained as the subtraction result (Step S207).

Then, the sampling data analyzing unit 15 obtains, as the current block performance counter values, the counter values of the last column in the block performance counter table 209. Moreover, the sampling data analyzing unit 15 calculates the average value of the block performance counter values of the methods from the fourth-last column to the second-last column in the block performance counter table 209, and treats the average value as the past block performance counter value. Then, the sampling data analyzing unit 15 divides the current block performance counter values by the past block performance counter value, and calculates the increment rate of each block performance counter (Step S208). Subsequently, the sampling data analyzing unit 15 generates, for each method, the increment rate table 210 in which the past block performance counter value, the current block performance counter value, and the increment rate of the block performance counter are registered.

Then, the sampling data analyzing unit 15 determines whether or not the post-flushing flag 208 in the last columns of the block performance counter table 209 is set to true (Step S209). If the post-flushing flag 208 is set to false (No at Step S209), then the system control proceeds to Step S214.

On the other hand, if the post-flushing flag 208 is set to true (Yes at Step S209), then the sampling data analyzing unit 15 obtains, from the compilation executing unit 13, the information about all methods that were compiled within 10 seconds after the execution of code cache flushing. Moreover, the sampling data analyzing unit 15 obtains, from the flushing method list 203, the methods that were deleted during the previous execution of code cache flushing. Then, the sampling data analyzing unit 15 updates the recompilation list 213 (Step S210).

Subsequently, the sampling data analyzing unit 15 obtains, from the increment rate table 210, the past block performance counter value and the increment rate of the block performance counter of each method registered in the increment rate table 210. Moreover, the sampling data analyzing unit 15 obtains the recompilation count of each method from the recompilation list 213. Furthermore, the sampling data analyzing unit 15 obtains the information about the current-flushing flag of each method from the flushing method list 203. Then, the sampling data analyzing unit 15 determines whether or not any method satisfies the flushing exemption conditions (Step S211). The flushing exemption conditions include: the condition that the current-flushing flag is set to true; the condition that the increment rate of the block performance count is equal to or greater than the impact degree threshold value; the condition that the past block performance counter value is equal to or greater than the constant execution threshold value; and the condition that the recompilation count is equal to or greater than the nonefficiency threshold value.

If there is no method that satisfies the flushing exemption conditions (No at Step S211), then the system control proceeds to Step S213.

On the other hand, if any method satisfies the flushing exemption conditions (Yes at Step S211), then the sampling data analyzing unit 15 adds that method in the deletion exemption list 204 regarding code cache flushing (Step S212).

Then, the sampling data analyzing unit 15 sets the post-flushing flag of the current evaluation block to false in the block performance counter table 209 (Step S213).

Subsequently, the sampling data analyzing unit 15 determines whether or not the processes of the Java program have ended or an instruction to stop the sampling is received (Step S214). If the processes of the Java program have not ended and if an instruction to stop the sampling is not received (No at Step S214), then the system control returns to Step S201.

On the other hand, if the processes of the Java program have ended or if an instruction to stop the sampling is received (Yes at Step S214), then the sampling data analyzing unit 15 ends the sampling data analysis operation.

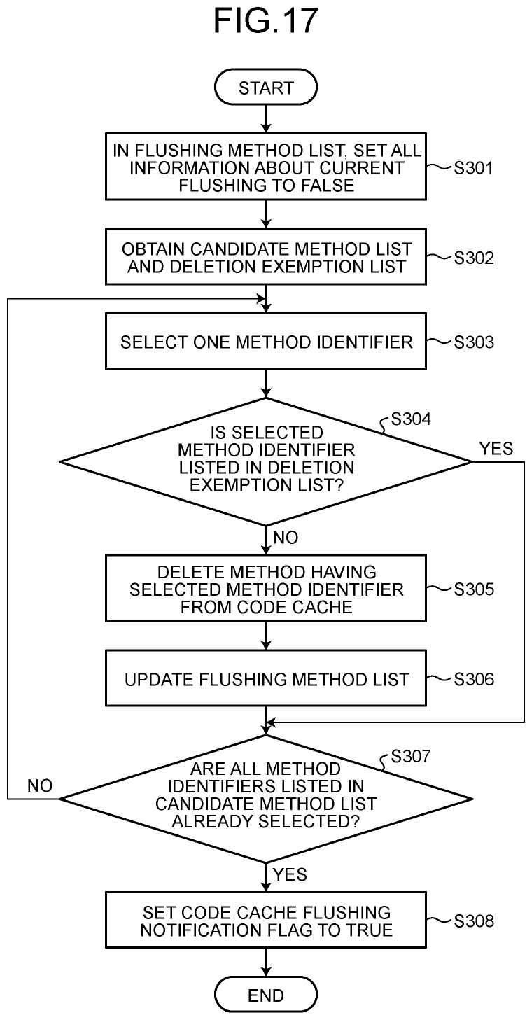

FIG. 17 is a flowchart for explaining an example of a code cache flushing operation. Thus, explained below with reference to FIG. 17 is the flow of the code cache flushing operation performed by the code cache flushing executing unit 14. The operations illustrated in the flowchart in FIG. 17 represent an example of the operations performed at Step S5 in the flowchart illustrated in FIG. 14.

The code cache flushing executing unit 14 receives a request for performing code cache flushing from the compilation executing unit 13. Then, the code cache flushing executing unit 14 sets all information about the current flushing in the flushing method list 203 to false (Step S301).

Subsequently, the code cache flushing executing unit 14 obtains the candidate method list 202 from the process memory 20. Moreover, the code cache flushing executing unit 14 obtains the deletion exemption list 204 from the process memory 20 (Step S302).

Then, the code cache flushing executing unit 14 selects a single method identifier from the candidate method list 202 (Step S303).

Subsequently, the code cache flushing executing unit 14 determines whether or not the selected method identifier is listed in the deletion exemption list 204 (Step S304).

If the selected method identifier is listed in the deletion exemption list 204 (Yes at Step S304), then the system control proceeds to Step S307.

On the other hand, if the selected method identifier is not listed in the deletion exemption list 204 (No at Step S304), then the code cache flushing executing unit 14 deletes, from the code cache 201, the method having the selected method identifier (Step S305).

If any deleted method is still not registered in the flushing method list 203, then the code cache flushing executing unit 14 adds the method identifier of that method in the flushing method list 203. Subsequently, the code cache flushing executing unit 14 sets the flushing count corresponding to the added method identifier to “1”, and sets the current-flushing flag to true. Moreover, regarding the deleted methods that are already registered in the flushing method list 203, the code cache flushing executing unit 14 increments, by one, the flushing count corresponding to the method identifiers of those methods. Furthermore, the code cache flushing executing unit 14 sets the current-flushing flag to true. With that, the code cache flushing executing unit 14 updates the flushing method list 203 stored in the process memory 20 (Step S306).

Then, the code cache flushing executing unit 14 determines whether or not all method identifiers listed in the candidate method list 202 have been selected (Step S307). If any method identifier is yet to be selected (No at Step S307), then the system control returns to Step S303.

When all method identifiers listed in the candidate method list 202 are already selected (Yes at Step S307), the code cache flushing executing unit 14 sets the code cache flushing notification flag 207 to true (Step S308).

As explained above, the information processing device according to the present embodiment determines that a method for which the execution duration according to the native code and the execution duration according to the interpreter is different by a value equal to or greater than the impact degree threshold value is a method that exercises a large impact on the performance. Moreover, the information processing device determines that a method which is executed over a long period of time and which is often recompiled immediately after being deleted during code cache flushing is an important method. Then, the information processing device performs code cache flushing by excluding, from the target methods for flushing, the methods that exercise a large impact on the performance and that are important. As a result, the methods that are important to the performance and that exercise a large impact on the performance can be prevented from being returned to the interpreter, thereby enabling lessening the performance degradation during program execution in the information processing device. Meanwhile, in case there occurs any performance trouble, the impact of the code cache shortage and code cache flushing can be analyzed at the execution status level of the methods, thereby enabling tuning to the appropriate code cache size. As a result, a large-scale system can be operated in a stable manner for a long period of time.

Moreover, during code cache flushing, there arises the issue of fragmentation of the code cache. The characteristics of the code cache are such that compaction of the regions is difficult to achieve and fragmentation occurs easily. For example, when the address of a particular native code is embedded in another native code, if the address of that particular native code gets changed due to compaction, all the parts referring to that address need to be rewritten. In this way, if the increase in the amount of processing due to compaction is taken into account, then it becomes difficult to easily perform compaction with respect to the code cache. In that case, although the regions in which the deleted codes were stored are reusable, if a native code that is created at a later timing has a larger size than the size of the continuous free space, then it becomes difficult to store that native code. Hence, practically speaking, there occurs a shortage in the code cache region. When there is a shortage in the code cache, the conversion of native codes does not be performed in an appropriate manner, thereby leading to the risk of degradation in the performance of the computer.

In that regard, the information processing device according to the present embodiment analyzes the fragmentation status of the code cache during code cache flushing. That makes it possible to easily determine whether or not the code cache fragmentation is causing a shortage in the code cache.

Moreover, conventionally, when a method that is important to the performance is deleted or when there is a shortage in the code cache region, it is difficult to determine whether or not that issue is affecting the performance of the applications. For example, in the conventional method sampling, the code that is being executed in the CPU is periodically verified, and the method-by-method execution counts are counted. When method sampling is performed, the method having a large execution count is determined to have been using the CPU a lot. Generally, method sampling is performed at the time of identifying a method that uses the CPU a lot during application execution and then improving that method. As a method for determining the way in which the deletion of methods that are important to the performance and fragmentation-induced shortage of the code cache impact the applications, it is possible to think of using method sampling or using a tool in which method sampling is implemented, and identifying and visualizing the methods having a high execution frequency.

However, in method sampling, although it is possible to collect the sampling of the methods executed by an application during a certain period of time, it is difficult to analyze the relationship with the code cache shortage or code cache flushing. That is, in the existing method sampling, it is difficult to analyze the way in which the deletion of the methods that are important to the performance or fragmentation-induced shortage in the code cache region affects the operation performance of the applications.

In that regard, in the information processing device according to the present embodiment, instead of using the CPU usage time of each method, the number of sets of sampling data obtained during method sampling is used for evaluating the execution duration of each method. As a result, in the information processing device according to the present embodiment, as a result of performing method sampling, it becomes possible to analyze the way in which the deletion of the methods that are important to the performance or fragmentation-induced shortage in the code cache region affects the operation performance of the applications. Moreover, it becomes possible to lessen the processing load for figuring out the execution status of the methods.

As an aspect of the present invention, it becomes possible to lessen the performance degradation of an information processing device.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein an information processing program that causes a computer to execute a process comprising:
deleting that, when a cache having codes of a plurality of methods stored therein has insufficient space for storing other codes, includes
referring to a deletion exemption list, and
deleting, from the cache, a first-type code of a first-type method selected from among such other methods, from among the plurality of methods, which do not include methods listed in the deletion exemption list;
measuring execution duration of the first-type method after every predetermined period of time; and
registering the first-type method in the deletion exemption list based on
execution duration of the first-type method during period of time that, of the predetermined period of time, is before deletion of the first-type code from the cache and during period of time that, of the predetermined period of time, is after deletion of the first-type code from the cache, and
number of times for which the first-type code is stored in the cache within certain period of time after deletion of the first-type code.

2. The non-transitory computer-readable recording medium according to claim 1, wherein, when increment rate of execution duration of the first-type method in the period of time after deletion with respect to execution duration of the first-type method in the period of time before deletion is equal to or greater than a first threshold value, according to execution duration of the first-type method during the period of time before deletion and according to number of times for which the first-type code is stored in the cache within certain period of time after deletion of the first-type code, information indicating the first-type code is registered in the deletion exemption list.

3. The non-transitory computer-readable recording medium according to claim 2, wherein, when execution duration of the first-type method during the period of time before deletion is equal to or grater than a second threshold value and when number of times of occurrence of an event in which the first-type code is stored in the cache within certain period of time after deletion of the first-type code is equal to or greater than a third threshold value, information indicating the first-type code is registered in the deletion exemption list.

4. The non-transitory computer-readable recording medium according to claim 1, wherein
extraction count of the first-type method is obtained by
extracting methods that are executed by a central processing unit (CPU) at specific intervals during each of the predetermined period, and
calculating extraction count of each method, and
the obtained extraction count of the first-type method is treated as the execution duration of the first-type method.

5. An information processing method implemented in an information processing device, comprising:
deleting that, when a cache having codes of a plurality of methods stored therein has insufficient space for storing other codes, includes
referring to a deletion exemption list, and
deleting, from the cache, a first-type code of a first-type method selected from among such other methods, from among the plurality of methods, which do not include methods listed in the deletion exemption list;
measuring execution duration of the first-type method after every predetermined period of time; and
registering the first-type method in the deletion exemption list based on
execution duration of the first-type method during period of time that, of the predetermined period of time, is before deletion of the first-type code from the cache and during period of time that, of the predetermined period of time, is after deletion of the first-type code from the cache, and
number of times for which the first-type code is stored in the cache within certain period of time after deletion of the first-type code, by a processor.

6. An information processing device comprising:
a memory; and
a processor coupled to the memory and configured to [symbol] [symbol]
, when a cache having codes of a plurality of methods stored therein has insufficient space for storing other codes,
refer to a deletion exemption list, and
delete, from the cache, a first-type code of a first-type method selected from among such other methods, from among the plurality of methods, which do not include methods listed in the deletion exemption list;
measure execution duration of the first-type method after every predetermined period of time,
register the first-type method in the deletion exemption list based on
execution duration of the first-type method during period of time that, of the predetermined period of time, is before deletion of the first-type code from the cache and during period of time that, of the predetermined period of time, is after deletion of the first-type code from the cache, and
number of times for which the first-type code is stored in the cache within certain period of time after deletion of the first-type code.
